(19) United States
(12) Patent Application Publication
(10) Pub. No.: US 2016/0340571 A1
(43) Pub. Date: Nov. 24, 2016

(54) Compositions and Methods for Hydrophobically Modifying Fracture Faces

(71) Applicant: HALLIBURTON ENERGY SERVICES, INC., Houston, TX (US)

(72) Inventors: Feng Liang, Cypress, TX (US); Philip D. Nguyen, Houston, TX (US); Corneliu Stanciu, Kingwood, TX (US)

(73) Assignee: Halliburton Energy Services, Inc., Houston, TX (US)

(21) Appl. No.: 15/114,533

(22) PCT Filed: Apr. 3, 2014
(86) PCT No.: PCT/US2014/032744

§ 371 Date: Jul. 27, 2016

(51) Int. Cl. C09K 8/68; E21B 43/267; E21B 43/26; C09K 8/88; C09K 8/80

(52) U.S. Cl. CPC C09K 8/68; C09K 8/885; C09K 8/882; C09K 8/805; E21B 43/26; E21B 43/267

(57) ABSTRACT

Methods and compositions for hydrophobically modifying fracture faces may utilize hydrophobically modified amine-containing polymers. For example, a method may include providing a treatment fluid that comprises a base fluid, an HMAP dispersed in the base fluid, and an HMAP-coated proppant, the HMAP comprising a plurality of hydrophobic modifications on an amine-containing polymer; introducing the treatment fluid into a wellbore penetrating a subterranean formation, wherein the subterranean formation comprises at least one fracture; and treating at least a portion of the subterranean formation adjacent to a face of the at least one fracture with the HMAP dispersed in the base fluid.

### BACKGROUND

The present application relates to methods and compositions for hydrophobically modifying fracture faces with hydrophobically modified amine-containing polymers.

Hydrocarbon-producing wells are often stimulated by fracturing treatments. In such hydraulic fracturing treatments, a viscous fracturing fluid, which also functions as a carrier fluid, is pumped or injected into a producing zone at a rate and pressure such that the subterranean formation breaks down and one or more fractures are formed in the zone. Typically, particulate solids, such as proppant (e.g., graded sand, etc.) suspended in a portion of the fracturing fluid, are then deposited in the fractures; once deposited, the fracturing fluid is converted to a thin fluid to be returned to the surface. These particulate solids, or “proppant particulates,” may serve to prevent the fractures from fully closing so that conductive channels are formed through which produced hydrocarbons can flow from producing zones in the formation.

In many instances, fracturing fluids include aqueous base fluids. In some instances, the aqueous base fluid may intercalate the pore spaces, vugs, and fractures of the formation and may be held in place through attractive forces with a hydrophilic surface of the formation. This aqueous fluid may then reduce the mobility of the native hydrocarbon and thereby limit hydrocarbon production of the well. Therefore, after placement of a proppant pack, the aqueous carrier fluid may be flowed back to the wellbore and recovered so as to mitigate any reductions in hydrocarbon production.

### BRIEF DESCRIPTION OF THE DRAWING

The following figure is included to illustrate certain aspects of the embodiments, and should not be viewed as exclusive embodiments. The subject matter disclosed is capable of considerable modifications, alterations, combinations, and equivalents in form and function, as will occur to those skilled in the art and having the benefit of this disclosure.

FIG. 1 shows an illustrative schematic of a system for delivering fluids described herein to a downhole location, according to one or more embodiments.

### DETAILED DESCRIPTION

The present application relates to methods and compositions for hydrophobically modifying fracture faces with hydrophobically modified amine-containing polymers.

As used herein, the term “hydrophobically modified amine-containing polymer” (or “HMAP”) is used to describe amine-containing polymers (i.e., polymers with an amine in the polymer backbone, polymer branches, or in both the backbone and branches) that have been hydrophobically modified. In some embodiments, the HMAP described herein may be used to coat surfaces (e.g., formation surfaces and particle surfaces) and enhance the hydrophobicity thereof. Without being limited by theory, it is believed that using the HMAP to enhance the permeability of aqueous fluids through the proppant packs and fractures creates a lower risk of the aqueous fluid becoming embedded in the pore spaces, vugs, and fractures of the formation. Therefore, aqueous fluids (e.g., wellbore fluids or formation fluids) may be recovered from the formation more readily, which may mitigate issues related to water reducing access to hydrocarbon reserves.

As used herein, the term “coating,” and the like, does not imply any particular degree of coating on a particulate. In particular, the terms “coat” or “coating” do not imply 100% coverage by the coating on a particulate. It should be understood that the terms “particulate” or “particle” as used in this disclosure, includes all known shapes of materials, including substantially spherical materials, fibrous materials, polygonal materials (such as cubic materials), and combinations thereof.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the embodiments of the present invention. At the very least, and not as an attempt to limit the application of the doctrine of equivalents to the scope of the claim, each numerical parameter should at least be construed in light of the number of reported significant digits and by applying ordinary rounding techniques. Further, it should be noted that when “about” is provided herein at the beginning of a numerical list, “about” modifies each number of the numerical list. It should be noted that in some numerical listings of ranges, some lower limits listed may be greater than some upper limits listed. One skilled in the art will recognize that the selected subset will require the selection of an upper limit in excess of the selected lower limit.

As described above, the HMAP described herein are amine-containing polymers that have been hydrophobically modified. Examples of amine-containing polymers may include, but are not limited to, polyamines (e.g., spermidine and spermine), polyimines (e.g., poly(ethylene imine) and poly(propylene imine)), polyamides, poly(2-(N,N-dimethylamino)ethyl methacrylate), poly(2-(N,N-diethylamino)ethyl methacrylate), poly(vinyl imidazole), and the like, any copolymer thereof, and any combination thereof. Further, amine-containing polymers may include a copolymer of at least one of the foregoing amine-containing polymers (or corresponding monomer unit) and at least one polymer (or corresponding monomer unit) that does not contain an amine (e.g., polyethylene, polypropylene, polyethylene oxide, polypropylene oxide, polyvinylpyridine, polyacrylic acid, polyacrylate, polymethacrylate, and the like).

Hydrophobic modifications may, in some embodiments, include, but are not limited to, a C₄-C₃₀ characterized by at least one selected from the group consisting of a straight chain, a branched chain, comprising an unsaturated C—C bond, comprising an aryl group, and the like, and any combination thereof.

Formulas I-III provide examples of the HMAP described herein wherein Z is R or COR, and wherein R is a hydrophobic modification described herein (e.g., a C₄-C₃₀ characterized by at least one selected from the group consisting of a straight chain, a branched chain, comprising an unsaturated C—C bond, comprising an aryl group, and the like, and any combination thereof).

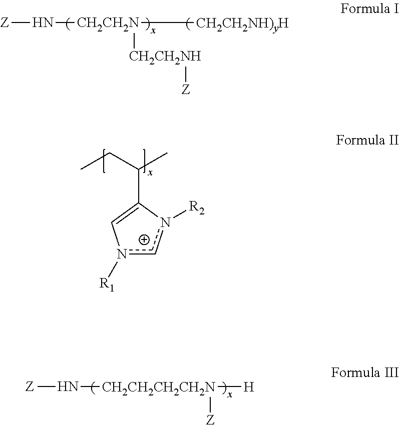

In some embodiments, the HMAP may have a degree of modification such that the amount hydrophobic modification ranges from a lower limit of about 0.1%, 1%, 10%, or 30% by molar ratio of amine content to an upper limit of about 99.9%, 95%, 70%, or 50% by molar ratio of amine content, and wherein the amount of hydrophobic modification may range from any lower limit to any upper limit and encompass any subset therebetween.

In some embodiments, the HMAP may have a molecular weight ranging from a lower limit of about 300 g/mol, 1,000 g/mol, 10,000 g/mol, or 100,000 g/mol to an upper limit of about 3,000,000 g/mol, 1,000,000 g/mol, or 100,000 g/mol, and wherein the molecular weight may range from any lower limit to any upper limit and encompass any subset therebetween.

In some embodiments, hydrophobic modifications may be achieved via a plurality of reaction schemes including, but not limited to, amidation with carboxy terminal compounds (e.g., fatty acids), quaternization by alkyl halides, addition reactions with alpha-olefins, nucleophilic attack with alkyl compounds having active groups (e.g., a terminal epoxide), and the like, and any combination thereof.

In some embodiments, the HMAP described herein may be dispersed in the base fluid in a treatment fluid at a concentration ranging from a lower limit of about 0.01%, 0.05%, or 0.1% by weight of the base fluid to an upper limit of about 3%, 1%, or 0.5% by weight of the base fluid, wherein the concentration of the HMAP may range from any lower limit to any upper limit and encompass any range therebetween.

Some embodiments may involve coating or treating particulates (e.g., formation fines, formation sand, proppants, and/or gravel particulates), fracture faces in a subterranean formation, and portions of the formation adjacent to the fracture faces with an HMAP described herein, thereby increasing the hydrophobicity of the particulates and formation faces. As used herein, the term “HMAP-coated particulates” refer to particles that are at least partially coated with HMAP described herein.

In some embodiments, a treatment fluid may comprise a base fluid, an HMAP dispersed in the base fluid, and an HMAP-coated particle (e.g., an HMAP-coated proppant or gravel particle), the HMAP comprising a plurality of hydrophobic modifications on an amine-containing polymer.

Some embodiments may involve precoating particulates (e.g., gravel particulates and/or proppants) with the HMAP before addition to a treatment fluid (i.e., adding HMAP-coated particulates to a treatment fluid). In some instances, the HMAP-coated particulates may be produced by dry-coating or wet-coating methods.

In other embodiments, the particulates may be coated with the HMAP while preparing the treatment fluid. For example, some embodiments may involve adding HMAP to a mixture comprising the base fluid and particulates. In another example, some embodiments may involve adding particulates to a mixture of base fluid and the HMAP. In either embodiment or a hybrid thereof, the resultant treatment fluid may then be introduced in the wellbore.

In some embodiments, an optional coupling agent (e.g., a silane coupling agent or surfactant) may be used, among other things, to act as a mediator to help bond the HMAP to the rock surfaces in the formation.

Examples of suitable silane coupling agents include, but are not limited to, N-2-(aminoethyl)-3-aminopropyltrimethoxysilane, and 3-glycidoxypropyltrimethoxysilane, and combinations thereof. In some embodiments, the coupling agent may be present in a treatment fluid at a concentration ranging from a lower limit of about 0.001%, 0.05%, or 0.1% by weight of the HMAP to an upper limit of about 3%, 1%, or 0.5% by weight of the HMAP, wherein the concentration of the silane coupling agent may range from any lower limit to any upper limit and encompass any range therebetween.

In some embodiments, the particulates or HMAP-coated particulates may be present in a treatment fluid at a concentration ranging from a lower limit of about 0.1 pounds per gallon (“ppg”), 1 ppg, or 5 ppg to an upper limit of about 30 ppg, 20 ppg, or 10 ppg by volume of the treatment fluid, wherein the concentration of the particulates or HMAP-coated particulates may range from any lower limit to any upper limit and encompass any range therebetween.

In some instances, the treatment fluids described herein may be used in hydraulic fracturing operations. For example, some embodiments may involve using HMAP and HMAP-coated particulates in fracturing operations, which may involve (1) optionally introducing a prepad fluid into the subterranean formation, (2) introducing a pad fluid into the subterranean formation to initiate and create at least one fracture, (3) introducing a proppant slurry (e.g., comprising a base fluid, an HMAP dispersed in the base fluid, and an HMAP-coated particle) into the subterranean formation so as to place the proppant into the fracture, thereby forming a proppant pack in at least a portion of the fracture and coating or treating at least a portion of the subterranean formation adjacent to a face of the at least one fracture with the HMAP dispersed in the base fluid, and (4) optionally introducing a flush fluid into the subterranean formation. Prepad fluids are generally introduced at or below matrix pressure and before pad fluids. Pad fluids are generally introduced above matrix pressure (i.e., at a pressure sufficient to create or extend at least one fracture in the subterranean formation).

In some instances, the treatment fluids described herein may be used in high rate water fracturing or slickwater fracturing operations. The term “slickwater” refers to low viscosity fluid (i.e., a viscosity less than that used for hydraulic fracturing) (e.g., less than about 20 cP or less than about 10 cP) containing friction reducing agents to modify the flow characteristics of the fluid. Exemplary friction reduction agents include polyethylene oxide and polyvinyl polymers, polymethacrylamides, cellulose ethers, polysaccharides, and lignosulfonates.

Some embodiments may involve using HMAP and HMAP-coated particulates in fracturing operations, which may involve introducing a treatment fluid (e.g., comprising a base fluid, an HMAP dispersed in the base fluid, and an HMAP-coated particle) into the subterranean formation at a pressure and rate sufficient to create or extend at least one fracture.

The methods and compositions described herein may be used in full-scale operations or pills. As used herein, a “pill” is a type of relatively small volume of specially prepared treatment fluid placed or circulated in the wellbore.

Some embodiments may involve producing hydrocarbon fluids from the portion of the subterranean formation having been treated with the HMAP and HMAP-coated particulates described herein.

Base fluids suitable for use in conjunction with the present may include aqueous fluids, aqueous-miscible fluids, and any combination thereof.

Aqueous fluids suitable for use in conjunction with the embodiments described herein may comprise fresh water, saltwater (e.g., water containing one or more salts dissolved therein), brine (e.g., saturated salt water or produced water), seawater, produced water (e.g., water produced from a subterranean formation), aqueous-miscible fluids, and any combination thereof.

Generally, the water may be from any source, provided that it does not contain components that might adversely affect the stability and/or performance of the first treatment fluids or second treatment fluids.

Suitable aqueous-miscible fluids may include, but not be limited to, alcohols (e.g., methanol, ethanol, n-propanol, isopropanol, n-butanol, sec-butanol, isobutanol, and t-butanol), glycerins, glycols (e.g., polyglycols, propylene glycol, and ethylene glycol), polyglycol amines, polyols, any derivative thereof, any in combination with salts (e.g., sodium chloride, calcium chloride, calcium bromide, zinc bromide, potassium carbonate, sodium formate, potassium formate, cesium formate, sodium acetate, potassium acetate, calcium acetate, ammonium acetate, ammonium chloride, ammonium bromide, sodium nitrate, potassium nitrate, ammonium nitrate, ammonium sulfate, calcium nitrate, sodium carbonate, and potassium carbonate), any in combination with an aqueous fluid, and any combination thereof.

In certain embodiments, the density of the base fluid can be adjusted, among other purposes, to provide additional particulate transport and suspension in the treatment fluids used in the methods described herein. In certain embodiments, the pH of the base fluid may be adjusted (e.g., by a buffer or other pH adjusting agent), among other purposes, to activate a crosslinking agent and/or to reduce the viscosity of the first treatment fluid (e.g., activate a breaker, deactivate a crosslinking agent). In these embodiments, the pH may be adjusted to a specific level, which may depend on, among other factors, the types of gelling agents, acids, and other additives included in the treatment fluid. One of ordinary skill in the art, with the benefit of this disclosure, will recognize when such density and/or pH adjustments are appropriate.

In some embodiments, the base fluid may be foamed. In some embodiments a treatment fluid for use in conjunction with the embodiments described herein may comprise a base fluid, a gas, a foaming agent, and at least one of particulates, particulates in combination with HMAP, HMAP-coated particulates, or HMAP-coated particulates in combination with HMAP.

In some embodiments, the gas is selected from the group consisting of nitrogen, carbon dioxide, air, methane, helium, argon, and any combination thereof. One skilled in the art, with the benefit of this disclosure, should understand the benefit of each gas. By way of nonlimiting example, carbon dioxide foams may have deeper well capability than nitrogen foams because carbon dioxide emulsions have greater density than nitrogen gas foams so that the surface pumping pressure required to reach a corresponding depth is lower with carbon dioxide than with nitrogen.

In some embodiments, the quality of the foamed treatment fluid may range from a lower limit of about 5%, 10%, 25%, 40%, 50%, 60%, or 70% gas volume to an upper limit of about 95%, 90%, 80%, 75%, 60%, or 50% gas volume, and wherein the quality of the foamed treatment fluid may range from any lower limit to any upper limit and encompass any subset therebetween. Most preferably, the foamed treatment fluid may have a foam quality from about 85% to about 95%, or about 90% to about 95%.

Suitable foaming agents for use in conjunction with the embodiments described herein may include, but are not limited to, cationic foaming agents, anionic foaming agents, amphoteric foaming agents, nonionic foaming agents, or any combination thereof. Nonlimiting examples of suitable foaming agents may include, but are not limited to, surfactants like betaines, sulfated or sulfonated alkoxylates, alkyl quaternary amines, alkoxylated linear alcohols, alkyl sulfonates, alkyl aryl sulfonates, C₁₀-C₂₀ alkyldiphenyl ether sulfonates, polyethylene glycols, ethers of alkylated phenol, sodium dodecylsulfate, alpha olefin sulfonates such as sodium dodecane sulfonate, trimethyl hexadecyl ammonium bromide, and the like, any derivative thereof, or any combination thereof. Foaming agents may be included in foamed treatment fluids at concentrations ranging typically from about 0.05% to about 2% of the liquid component by weight (e.g., from about 0.5 to about 20 gallons per 1000 gallons of liquid).

Suitable proppants for use in conjunction with the embodiments described herein may be any material suitable for use in subterranean operations. Examples of these particulates may include, but are not limited to, sand, bauxite, ceramic materials, glass materials, polymer materials, polytetrafluoroethylene materials, nut shell pieces, cured resinous particulates comprising nut shell pieces, seed shell pieces, cured resinous particulates comprising seed shell pieces, fruit pit pieces, cured resinous particulates comprising fruit pit pieces, wood, composite particulates, and combinations thereof. Suitable composite particulates may comprise a binder and a filler material wherein suitable filler materials include silica, alumina, fumed carbon, carbon black, graphite, mica, titanium dioxide, meta-silicate, calcium silicate, kaolin, talc, zirconia, boron, fly ash, hollow glass microspheres, solid glass, and combinations thereof. The mean particulate size generally may range from about 2 mesh to about 400 mesh on the U.S. Sieve Series; however, in certain circumstances, other mean particulate sizes may be desired and will be entirely suitable for practice of the embodiments described herein. In particular embodiments, preferred mean particulates size distribution ranges are one or more of 6/12, 8/16, 12/20, 16/30, 20/40, 30/50, 40/60, 40/70, or 50/70 mesh. Moreover, fibrous materials, that may or may not be used to bear the pressure of a closed fracture, may be included in certain described herein.

In some embodiments, treatment fluids described herein may further comprise additives. Suitable additives may include, but are not limited to, salts, weighting agents, inert solids, fluid loss control agents, emulsifiers, dispersion aids, corrosion inhibitors, emulsion thinners, emulsion thickeners, viscosifying agents, gelling agents, surfactants, particulates, lost circulation materials, pH control additives, breakers, biocides, crosslinkers, stabilizers, chelating agents, gas hydrate inhibitors, mutual solvents, oxidizers, reducers, friction reducers, clay stabilizing agents, or any combination thereof. One skilled in the art with the benefit of this disclosure should understand the appropriate additives and concentrations thereof for use in conjunction with the embodiments described herein to achieve the desired result and so as to maintain operability of the methods described herein.

In various embodiments, systems may be configured for delivering the fluids described herein to a downhole location. In various embodiments, the systems can comprise a pump fluidly coupled to a tubular, the tubular containing a treatment fluid comprising a base fluid and a plurality of HMAP-coated particulates that comprise particulates at least partially coated with an HMAP, wherein the HMAP comprises a plurality of hydrophobic modifications on an amine-containing polymer. In various embodiments, the systems can comprise a pump fluidly coupled to a tubular, the tubular containing a treatment fluid comprising a base fluid and HMAP, wherein the HMAP comprises a plurality of hydrophobic modifications on an amine-containing polymer.

The pump may be a high pressure pump in some embodiments. As used herein, the term “high pressure pump” will refer to a pump that is capable of delivering a fluid downhole at a pressure of about 1000 psi or greater. A high pressure pump may be used when it is desired to introduce the treatment fluid to a subterranean formation at or above a fracture gradient of the subterranean formation, but it may also be used in cases where fracturing is not desired. In some embodiments, the high pressure pump may be capable of fluidly conveying particulate matter, such as proppant particulates, into the subterranean formation. Suitable high pressure pumps will be known to one having ordinary skill in the art and may include, but are not limited to, floating piston pumps and positive displacement pumps.

In other embodiments, the pump may be a low pressure pump.

As used herein, the term “low pressure pump” will refer to a pump that operates at a pressure of about 1000 psi or less. In some embodiments, a low pressure pump may be fluidly coupled to a high pressure pump that is fluidly coupled to the tubular. That is, in such embodiments, the low pressure pump may be configured to convey the treatment fluid to the high pressure pump. In such embodiments, the low pressure pump may “step up” the pressure of the treatment fluid before it reaches the high pressure pump.

In some embodiments, the systems described herein can further comprise a mixing tank that is upstream of the pump and in which the treatment fluid is formulated. In various embodiments, the pump (e.g., a low pressure pump, a high pressure pump, or a combination thereof) may convey the treatment fluid from the mixing tank or other source of the treatment fluid to the tubular. In other embodiments, however, the treatment fluid can be formulated offsite and transported to a worksite, in which case the treatment fluid may be introduced to the tubular via the pump directly from its shipping container (e.g., a truck, a railcar, a barge, or the like) or from a transport pipeline. In either case, the treatment fluid may be drawn into the pump, elevated to an appropriate pressure, and then introduced into the tubular for delivery downhole.

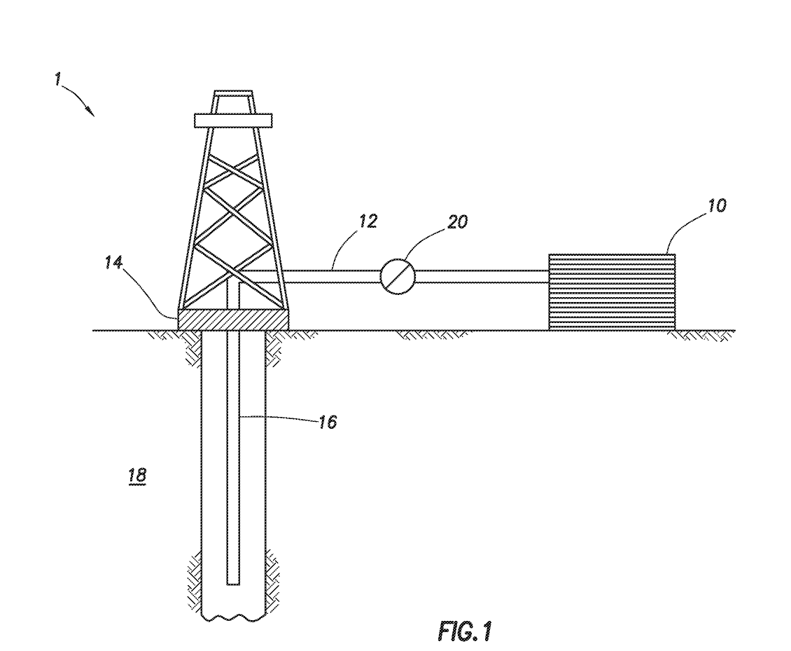

FIG. 1 shows an illustrative schematic of a system that can deliver treatment fluids of the present invention to a downhole location, according to one or more embodiments. It should be noted that while FIG. 1 generally depicts a land-based system, it is to be recognized that like systems may be operated in subsea locations as well. As depicted in FIG. 1, system 1 may include mixing tank 10, in which a treatment fluid of the present invention may be formulated. The treatment fluid may be conveyed via line 12 to wellhead 14, where the treatment fluid enters tubular 16, tubular 16 extending from wellhead 14 into subterranean formation 18. Upon being ejected from tubular 16, the treatment fluid may subsequently penetrate into subterranean formation 18. In some instances, tubular 16 may have a plurality of orifices (not shown) through which the treatment fluid of the present disclosure may enter the wellbore proximal to a portion of the subterranean formation 18 to be treated. In some instances, the wellbore may further comprise equipment or tools (not shown) for zonal isolation of a portion of the subterranean formation 18 to be treated.

Pump 20 may be configured to raise the pressure of the treatment fluid to a desired degree before its introduction into tubular 16. It is to be recognized that system 1 is merely exemplary in nature and various additional components may be present that have not necessarily been depicted in FIG. 1 in the interest of clarity. Non-limiting additional components that may be present include, but are not limited to, supply hoppers, valves, condensers, adapters, joints, gauges, sensors, compressors, pressure controllers, pressure sensors, flow rate controllers, flow rate sensors, temperature sensors, and the like.

Although not depicted in FIG. 1, the treatment fluid may, in some embodiments, flow back to wellhead 14 and exit subterranean formation 18. In some embodiments, the treatment fluid that has flowed back to wellhead 14 may subsequently be recovered and recirculated to subterranean formation 18.

It is also to be recognized that the disclosed treatment fluids may also directly or indirectly affect the various downhole equipment and tools that may come into contact with the treatment fluids during operation. Such equipment and tools may include, but are not limited to, wellbore casing, wellbore liner, completion string, insert strings, drill string, coiled tubing, slickline, wireline, drill pipe, drill collars, mud motors, downhole motors and/or pumps, surface-mounted motors and/or pumps, centralizers, turbolizers, scratchers, floats (e.g., shoes, collars, valves, etc.), logging tools and related telemetry equipment, actuators (e.g., electromechanical devices, hydromechanical devices, etc.), sliding sleeves, production sleeves, plugs, screens, filters, flow control devices (e.g., inflow control devices, autonomous inflow control devices, outflow control devices, etc.), couplings (e.g., electro-hydraulic wet connect, dry connect, inductive coupler, etc.), control lines (e.g., electrical, fiber optic, hydraulic, etc.), surveillance lines, drill bits and reamers, sensors or distributed sensors, downhole heat exchangers, valves and corresponding actuation devices, tool seals, packers, cement plugs, bridge plugs, and other wellbore isolation devices, or components, and the like. Any of these components may be included in the systems generally described above and depicted in FIG. 1.

Embodiments disclosed herein include:

A. a method that includes providing a treatment fluid that comprises a base fluid, an HMAP dispersed in the base fluid, and an HMAP-coated proppant; introducing the treatment fluid into a wellbore penetrating a subterranean formation, wherein the subterranean formation comprises at least one fracture having at least one face; and treating at least a portion of the subterranean formation adjacent to the at least one face of the at least one fracture with the HMAP dispersed in the base fluid;

B. a method that includes mixing a treatment fluid that comprises a base fluid, a plurality of particulates, and an HMAP, wherein the HMAP is at a concentration sufficient to coat the plurality of particulates and have excess dispersed in the base fluid; introducing the treatment fluid into a wellbore penetrating a subterranean formation, wherein the subterranean formation comprises at least one fracture; and treating at least a portion of the subterranean formation adjacent to a face of the at least one fracture with the HMAP dispersed in the base fluid;

C. a method that includes introducing a treatment fluid having a viscosity of about 20 cP or less into a wellbore penetrating a subterranean formation at a pressure and rate sufficient to create or extend at least one fracture, the treatment fluid comprising a base fluid, an HMAP dispersed in the base fluid, and an HMAP-coated proppant; and treating at least a portion of the subterranean formation adjacent to a face of the at least one fracture with the HMAP dispersed in the base fluid; and

D. a system that includes a wellhead with a tubular extending therefrom and into a wellbore in a subterranean formation; and a pump fluidly coupled to a tubular, the tubular containing a treatment fluid that comprises a base fluid, an HMAP dispersed in the base fluid, and an HMAP-coated proppant.

Each of embodiments A, B, C, and D may have one or more of the following additional elements in any combination: Element 1: wherein the amine-containing polymer comprises at least one selected from the group consisting of: a polyamine, a polyimine, a polyamide, poly(2-(N,N-dimethylamino)ethyl methacrylate), poly(2-(N,N-diethylamino)ethyl methacrylate), poly(vinyl imidazole), any copolymer thereof, and any combination thereof; Element 2: wherein the hydrophobic modification comprises a C₄-C₃₀ characterized by at least one selected from the group consisting of a straight chain, a branched chain, comprising an unsaturated C—C bond, comprising an aryl group, and any combination thereof; Element 3: wherein the HMAP is dispersed in the base fluid in an amount ranging from about 0.01% to about 3% by weight of the base fluid; Element 4: wherein the treatment fluid further comprises a coupling agent in an amount ranging from about 0.001% to about 3% by weight of the HMAP; Element 5: Element 4 wherein the coupling agent is a surfactant; Element 6: Element 4 wherein the coupling agent is a silane coupling agent; Element 7: wherein the treatment fluid is foamed; and Element 8: wherein the treatment fluid further comprises at least one additive selected from the group consisting of a salt, a weighting agent, an inert solid, a fluid loss control agent, an emulsifier, a dispersion aid, a corrosion inhibitor, an emulsion thinner, an emulsion thickener, a viscosifying agent, a gelling agent, a surfactant, a particulate, a lost circulation material, a pH control additive, a breaker, a biocide, a crosslinker, a stabilizer, a chelating agent, a scale inhibitor, a gas hydrate inhibitor, a mutual solvent, an oxidizer, a reducer, a friction reducer, a clay stabilizing agent, and any combination thereof. Each of

Embodiments A and B may further include: Element 9: the method further including introducing a pad fluid into the subterranean formation at a pressure sufficient to create or extend the at least one fracture in the subterranean formation before introducing the treatment fluid.

By way of non-limiting example, exemplary combinations applicable to Embodiments A, B, C, and D include: Element 1 in combination with Element 2 and optionally in combination with Element 3 and/or Element 4; Element 1 in combination with Element 3 and optionally in combination with Element 4; Element 2 in combination with Element 3 and optionally in combination with Element 4; and at least one of Elements 5-8 in combination with the foregoing. Further, Embodiments A and B may include: Element 9 in combination with any of the foregoing or Element 9 in combination with one of Elements 1-8.

One or more illustrative embodiments incorporating the invention embodiments disclosed herein are presented herein. Not all features of a physical implementation are described or shown in this application for the sake of clarity. It is understood that in the development of a physical embodiment incorporating the embodiments of the present invention, numerous implementation-specific decisions must be made to achieve the developer's goals, such as compliance with system-related, business-related, government-related and other constraints, which vary by implementation and from time to time. While a developer's efforts might be time-consuming, such efforts would be, nevertheless, a routine undertaking for those of ordinary skill the art and having benefit of this disclosure.

To facilitate a better understanding of the embodiments of the present invention, the following examples of preferred or representative embodiments are given. In no way should the following examples be read to limit, or to define, the scope of the invention.

### EXAMPLES

### Example 1

A sand column was prepared to mimic a gravel pack in a wellbore. The column had three layers: (1) 66 g of 20/40 Brady sand, (2) 22 g of Brazos River sand (with particle size smaller than 200 mesh to simulate formation fines) mixed with 44 g of 20/40 Brady sand, and (3) 66 g of 20/40 Brady sand. The sand in each of the three layers was dry-coated with 1.5 wt % of hydrophobically modified polyethyleneimine (40% active) before being packed into the column. The column was then heated to 180° F. and flushed with 200 mL of 5% KCl (approximately 2 pore volumes) from layer (1) through to layer (3). Then water was flowed through the column from the opposite direction, i.e., from layer (3) through to layer (1), to simulate wellbore production. The flow rate was started at 50 mL/min and increased to 100 mL/min then 150 mL/min. Effluents were collected at each flow rate where little to no Brazos River sand was observed in the effluents. When conducting a control experiment where the sand in each layer had not been coated/treated with the hydrophobically modified polyethyleneimine, Brazos River sand was observed in the effluents at each of the flow rates.

### Example 2

Another sand column was tested that included three layers: (1) 66 g of 20/40 Brady sand dry-coated with 3 wt % of hydrophobically modified polyethyleneimine (40% active), (2) 11 g of Brazos

River sand and 11 g of coal fines mixed with 44 g of 20/40 Brady sand (not treated), and (3) 66 g of 20/40 Brady sand (not treated). Effluents were collected at flow rates of 50 mL/min, 100 mL/min, 150 mL/min, and 200 mL/min. The effluents at 50 mL/min, 100 mL/min were grey and cloudy indicating that some of the coal fines were able to migrate through the simulated gravel pack, i.e., layer (1). However, the amount of coal fines observed is significantly less than the 11 g in the column, thereby demonstrating control of particulate migration. At the higher two flow rates little to no coal fines and Brazos River sand were observed in the effluents. This example demonstrates that hydrophobically modified polyethyleneimine can control the migration of formation fines at all flow rates just by treating the gravel pack alone.

### Example 3

Another sand column was tested that included three layers: (1) 66 g of 20/40 Brady sand (not treated), (2) 22 g of Brazos River sand mixed with 44 g of 20/40 Brady sand (not treated), and (3) 66 g of 20/40 Brady sand (not treated). In a procedure similar to Example 1, the column was flushed with KCl. However, then the column was flushed with 200 mL of 3 wt % of hydrophobically modified polyethyleneimine (40% activate) in isopropyl alcohol solution. Then, water was flowed in the opposite direction as described in Example 1. Effluents were collected at flow rates of 50 mL/min, 100 mL/min, 150 mL/min, and 200 mL/min, where little to no Brazos River sand was observed in the effluents. This indicates the effectiveness of the remedial treatment of HMAP for the formation.

### Example 4

Another sand column was prepared that included three layers: (1) 66 g of 20/40 Brady sand (not treated), (2) 22 g of WAC-9™ (a fluid loss control additive, available from Halliburton Energy Services, Inc.), which has a particle size of 325 mesh, mixed with 44 g of 20/40 Brady sand (not treated), and (3) 66 g of 20/40 Brady sand (not treated). The procedure of Example 3 was followed with effluents collected at 50 mL/min, 100 mL/min, 150 mL/min, and 200 mL/min. Each of the effluents were cloudy but with a total mass of WAC-9™ much less than what was originally placed in the column, thereby indicating some control of particulate migration. Without being limited by theory, it is believed that a higher concentration or thicker coating of hydrophobically modified polyethyleneimine may be needed for complete particulate migration control when working with smaller particulate sizes (e.g., as illustrated by comparing the results of Example 3 to Example 4).

### Example 5

Titanium flow cells (1-inch inner diameter and 2-inch length) was packed with 70/170-mesh sand, which simulates formation sand. Pressure transducers were installed at the inlet and outlet of the flow cells for measuring the pressure drop across the sand pack. The backpressure regulator was set at 800 psi. Each of the sand pack was first saturated by flowing four pore volumes (-50 mL) of 3% KCl brine and heated to 200° F.

In a control experiment, a simulated seawater was flowed at a rate of 5 mL/min. The simulated seawater was produced by simultaneous injecting Brine 1 and Brine 2 of Table 1 into the flow cell. The simulated seawater serves as a source for forming CaCO₃ scale. The pressure drop across the flow cell was measured during injection/flow of the simulated seawater. Over about a 4-hour period around 23 hours after flow began, the pressure drop across the flow cell increased rapidly from essentially no pressure difference to over 140 psi pressure difference. This indicates that the flow path through the sand pack was rapidly restricted due to scale buildup.

TABLE 1

| Brine 1 | | Brine 2 | |
|---|---|---|---|
| Composition | Amount (g/L) | Composition | Amount (g/L) |
| NaCl | 49.59 | NaCl | 49.59 |
| CaCl₂•2 H₂O | 7.48 | NaHCO₃ | 1.38 |
| MgCl₂•6 H₂O | 4.43 | | |
| KCl | 2.0781 | | |
| BaCl₂•2 H₂O | 1.0138 | | |
| SrCl₂•6 H₂O | 0.8824 | | |

To test an HMAP, the sand pack (after saturation with 3% KCl) was treated with three pore volumes (˜38 mL) of 4% hydrophobically modified polyethyleneimine (“PEI”) solution. This hydrophobic modified PEI was an amidation product of tall oil fatty acid (“TOFA”) and PEI with 50% molar ratio of hydrophobes based on the nitrogen sites of PEI. Then, the simulated seawater was flowed as described in the control experiment. Over a 55-hour test, the pressure drop across the flow cell remained the same at essentially no pressure drop. This indicates that the flow path through the sand pack is essentially unchanged and scale buildup in the flow path in negligible.

### Example 6

A polysaccharide gelling agent was prehydrated in water and adjusted to pH 9.7. A first HMAP fluid was prepared with 25 ppg polysaccharide gelling agent, 0.1 v/w% surfactant, and 1% v/w solution of 50% hydrophobically modified polyethyleneimine. A second HMAP fluid was prepared with 25 ppg polysaccharide gelling agent, 0.05 v/w% surfactant, and 2 v/w% solution of 50% hydrophobically modified polyethyleneimine. The fluid and sand were mixed in an FB4K blender (a blender, available from Halliburton Energy Services, Inc.) by pumping the fluid at 30 barrels per minute and the sand at various rates for different experiments. The slurry produced from mixing was allowed to settle, and the top fluids were decanted. The coated sands were rinsed with tap water 3 times.

The produced samples of coated sand were analyzed with a loss on ignition (“LOI”) test for amount of coating. The LOI test burns the samples to determine the amount of coating. The estimated LOI is the calculated weight percent of HMAP with 100% of the HMAP in the fluid coating the sand particles (i.e., not excess in the fluid). The actual LOI provides an indication of how much HMAP coats the sand particles (i.e., Estimated−Actual Free).

TABLE 2

| Sand | 1% v/w fluid | | 2% v/w fluid | |
|---|---|---|---|---|
| Flow | Estimated | Actual | Estimated | Actual |
| Rate | LOI (wt %) | LOI (wt %) | LOI (wt %) | LOI (wt %) |
| 1 ppg | 0.4 | 0.14 | 0.8 | 0.15 |
| 2 ppg | 0.4 | 0.17 | 0.8 | 0.20 |
| 3 ppg | 0.4 | 0.16 | 0.8 | 0.23 |
| 4 ppg | 0.4 | 0.18 | 0.8 | 0.26 |
| 8 ppg | — | — | 0.8 | 0.42 |
| 10 ppg | — | — | 0.8 | 0.63 |

This example demonstrates fluids with both HMAP-coated particles and free HMAP dispersed in the fluid. This free HMAP dispersed in the fluid may then be available for coating or treating fracture faces when implemented downhole.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present invention. The invention illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

1. A method comprising:
providing a treatment fluid that comprises a base fluid, a hydrophobically modified amine-containing polymer (“HMAP”) dispersed in the base fluid, and an HMAP-coated proppant;
introducing the treatment fluid into a wellbore penetrating a subterranean formation, wherein the subterranean formation comprises at least one fracture having at least one face; and
treating at least a portion of the subterranean formation adjacent to the at least one face of the at least one fracture with the HMAP dispersed in the base fluid.

2. The method of claim 1, wherein the amine-containing polymer comprises at least one selected from the group consisting of: a polyamine, a polyimine, a polyamide, poly(2-(N,N-dimethylamino)ethyl methacrylate), poly(2-(N,N-diethylamino)ethyl methacrylate), poly(vinyl imidazole), any copolymer thereof, and any combination thereof.

3. The method of claim 1, wherein the hydrophobic modification comprises a C₄-C₃₀ characterized by at least one selected from the group consisting of a straight chain, a branched chain, comprising an unsaturated C—C bond, comprising an aryl group, and any combination thereof.

4. The method of claim 1, wherein the HMAP is dispersed in the base fluid in an amount ranging from about 0.01% to about 3% by weight of the base fluid.

5. The method of claim 1, wherein the treatment fluid further comprises a coupling agent in an amount ranging from about 0.001% to about 3% by weight of the HMAP.

6. The method of claim 5, wherein the coupling agent is a surfactant.

7. The method of claim 5, wherein the coupling agent is a silane coupling agent.

8. The method of claim 1, wherein the treatment fluid is foamed.

9. The method of claim 1, wherein the treatment fluid further comprises at least one additive selected from the group consisting of a salt, a weighting agent, an inert solid, a fluid loss control agent, an emulsifier, a dispersion aid, a corrosion inhibitor, an emulsion thinner, an emulsion thickener, a viscosifying agent, a gelling agent, a surfactant, a particulate, a lost circulation material, a pH control additive, a breaker, a biocide, a crosslinker, a stabilizer, a chelating agent, a scale inhibitor, a gas hydrate inhibitor, a mutual solvent, an oxidizer, a reducer, a friction reducer, a clay stabilizing agent, and any combination thereof.

10. The method of claim 1 further comprising:
introducing a pad fluid into the subterranean formation at a pressure sufficient to create or extend the at least one fracture in the subterranean formation before introducing the treatment fluid.

11. A method comprising:
mixing a treatment fluid that comprises a base fluid, a plurality of particulates, and a hydrophobically modified amine-containing polymer (“HMAP”), wherein the HMAP is at a concentration sufficient to coat the plurality of particulates and have excess dispersed in the base fluid; and
introducing the treatment fluid into a wellbore penetrating a subterranean formation, wherein the subterranean formation comprises at least one fracture having at least one face; and
treating at least a portion of the subterranean formation adjacent to a face of the at least one fracture with the HMAP dispersed in the base fluid.

12. The method of claim 11, wherein the amine-containing polymer comprises at least one selected from the group consisting of a polyamine, a polyimine, a polyamide, poly(2-(N,N-dimethylamino)ethyl methacrylate), poly(2-(N,N-diethylamino)ethyl methacrylate), poly(vinyl imidazole), any copolymer thereof, and any combination thereof.

13. The method of claim 11, wherein the hydrophobic modification comprises a C₄-C₃₀ characterized by at least one selected from the group consisting of a straight chain, a branched chain, comprising an unsaturated C—C bond, comprising an aryl group, and any combination thereof.

14. The method of claim 11, wherein the HMAP is dispersed in the base fluid in an amount ranging from about 0.01% to about 3% by weight of the base fluid.

15. The method of claim 11, wherein the treatment fluid further comprises a coupling agent in an amount ranging from about 0.001% to about 3% by weight of the HMAP.

16. The method of claim 11, wherein the particulates are dispersed in the base fluid in an amount ranging from about 0.1 pounds per gallon to about 30 pounds per gallon of the treatment fluid.

17. The method of claim 11 further comprising:
introducing a pad fluid into the subterranean formation at a pressure sufficient to create or extend the at least one fracture in the subterranean formation before introducing the treatment fluid.

18. A method comprising:
introducing a treatment fluid at a viscosity of about 20 cP or less into a wellbore penetrating a subterranean formation at a pressure and rate sufficient to create or extend at least one fracture, the treatment fluid comprising a base fluid, a hydrophobically modified amine-containing polymer (“HMAP”) dispersed in the base fluid, and an HMAP-coated proppant; and
treating at least a portion of the subterranean formation adjacent to a face of the at least one fracture with the HMAP dispersed in the base fluid.

19. The method of claim 18, wherein the amine-containing polymer comprises at least one selected from the group consisting of a polyamine, a polyimine, a polyamide, poly(2-(N,N-dimethylamino)ethyl methacrylate), poly(2-(N,N-diethylamino)ethyl methacrylate), poly(vinyl imidazole), any copolymer thereof, and any combination thereof.

20. (canceled)

21. The method of claim 1, further comprising a tubular extending into the subterranean formation and a pump fluidly coupled to the tubular, the tubular containing containing a treatment fluid that comprises a base fluid, a hydrophobically modified amine-containing polymer (“HMAP”) dispersed in the base fluid, and an HMAP-coated proppant, wherein the HMAP comprises a plurality of hydrophobic modifications on an amine-containing polymer.
